(19) United States
(12) Patent Application Publication
(10) Pub. No.: US 2026/0266103 A1
(43) Pub. Date: Sep. 10, 2026

(54) MOTOR VEHICLE LOCK ASSEMBLY AND METHOD FOR PRODUCING SAME

(71) Applicant: Kiekert Aktiengesellschaft, Heiligenhaus (DE)

(72) Inventors: Jan SUK, Pardubice (CZ); Aleš KEJDANA, Prelouc (CZ)

(73) Assignee: Kiekert Aktiengesellschaft, Heiligenhaus (DE)

(21) Appl. No.: 18/876,367

(22) PCT Filed: May 12, 2023
(86) PCT No.: PCT/DE2023/100349

§ 371 Date: Dec. 18, 2024

(30) Foreign Application Priority Data
Jun. 22, 2022 (DE) 10 2022 115 496.3

(51) Int. Cl. E05B 79/02; E05B 81/64

(52) U.S. Cl. CPC E05B 79/02; E05B 81/64

(57) ABSTRACT

The invention relates to a motor vehicle lock assembly, in particular a motor vehicle bonnet lock assembly, which is equipped with a mechanical module (1) and an electrical module (2). The mechanical module (1) has at least one locking mechanism (3, 4) and a lock housing (5). In addition, the electrical module (2) is equipped with at least one electrical component carrier (6) and at least one electrical/electronic component (7) arranged thereon. The electrical module (2) can be fastened to the lock housing (5) of the mechanical module (1). According to the invention, the electrical component carrier (6) of the electrical mod-ule (2) engages releasably and electrically in a distortion-free manner into a corresponding latching aperture (5a) of the lock housing (5) of the mechanical module (1) by way of a latching lug (6a) in the course of a pivoting movement.

The invention relates to a motor vehicle lock assembly, in particular a motor vehicle bonnet lock assembly, having a mechanical module and an electrical module, wherein the mechanical module has at least one locking mechanism and a lock housing, wherein the electrical module is also equipped with at least one electrical component carrier and at least one electrical/electronic component arranged thereon or thereat, and wherein the electrical module can be fastened to the lock housing of the mechanical module.

Locking systems for motor vehicles or motor vehicle locks today consist substantially of two assemblies or modules, specifically the actual mechanical part of the lock as the mechanical module, which is responsible for locking the associated motor vehicle door or hood, and the electrical module, which carries the actuator, for example, and supplies it with the necessary electrical energy. The actuator system can have electric motors and gears. As the electric motors are controlled by a control apparatus and their position is monitored, the electrical module usually requires several additional sensors for position monitoring.

For this purpose, the electrical module has at least one electrical component carrier. The electrical component carrier is used on the one hand for electrical contacting of the individual electrical/electronic components, in particular the actuators and sensors, and on the other hand acts as a mechanical carrier for the components concerned. For this purpose, the electrical component carrier can be equipped with a punched grid, for example in a plastic carrier plate, which is molded through the plastic. In general, one or more conductor track foils can also be used for electrical contacting at this point. Combinations are also conceivable.

The electrical component carrier equipped with the electrical/electronic component arranged on it and consequently the electrical module is usually attached inside or to the lock housing of the mechanical module. This often requires various work steps as part of the previous procedure, for example the fixing of the electrical component carrier in or on the lock housing and its electrical contacting. As a result, soldering and screwing processes are often required in practice, as well as a hot stamping process under certain circumstances. All of these manufacturing steps not only require the additional use of materials such as solder, but are also time-consuming and therefore cost-intensive.

An electromechanical assembly for a vehicle locking system and consequently an electrical module with an electrical component carrier is described as an example in DE 10 2012 208 078A1 . For this purpose, the known electromechanical assembly has a switching device whose number of actuations is determined with the aid of an evaluation device.

In a door lock module for a vehicle door according to EP 1 087 082A2 , the electrical door lock there consists of a control part and a mechanical part connected to it. The electrical control unit is connected to the mechanical part of the door lock via an intermediate lever. The intermediate lever is designed in such a manner that it can be used to accommodate the tolerances of both lock parts that must be taken into account when attaching the door lock to an end face of the associated motor vehicle door.

In the context of the generic prior art according to DE 20 2015 009 935 U1, the electrical component carrier comprises a separate housing and can be attached to an outer surface of the associated motor vehicle lock. For this purpose, the design is such that the electrical component carrier interacts with holding means of the housing or lock housing of the motor vehicle lock. The holding means in question is a clip, snap and/or latching connection. This has proven to be fundamentally successful.

However, the known and generic procedure according to DE 20 2015 009 935 U1 is such that the connection between the electrical component carrier and the lock housing of the motor vehicle lock is ultimately brought about by a vertical plug connection, because the electrical component carrier also has two plug contacts that protrude from an extension of the electrical component carrier. When they are connected to the lock housing, the plug contacts engage in the corresponding sockets on the lock housing. The additional snap connection prevents the electrical component carrier from detaching from the lock housing.

In practice, the known procedure poses the problem that the plug contacts protruding from the electrical component carrier must be precisely aligned in relation to the two sockets on or in the lock housing that hold them during the respective connection. On the other hand, such plug contacts are relatively fragile and can be bent or, in the worst case, even break off during storage of the electrical component carrier or during assembly. All of this can lead to delays in installation and therefore increased costs. The invention as a whole seeks to remedy this.

The invention is based on the technical problem of further developing such a motor vehicle lock assembly in such a manner that it can be easily installed without the risk of damage.

To solve this technical problem, a generic motor vehicle lock assembly within the scope of the invention is characterized in that the electrical component carrier of the electrical module engages with a latching lug in a corresponding latching recess of the lock housing of the mechanical module in a detachable and electrically connection-free manner in the course of a pivoting movement, or vice versa.

In the context of the invention, a detachable coupling between the electrical component carrier, on the one hand, and the lock housing, on the other hand, is achieved by creating a snap-in connection at this point. The latching connection uses a latching lug on the electrical component carrier and a latching recess on or in the lock housing. In principle, this can also be reversed. In this case, the lock housing is equipped with the latching lug, which in turn engages releasably in the latching recess of the electrical component carrier in this case.

Of particular importance for the invention and in contrast to the generic prior art according to DE 20 2015 009 935U1, the design is such that the latching connection between the latching nose and the latching recess is established in the course of a pivoting movement. This means that the connection between the electrical component carrier and the lock housing via the latching connection is made by a pivoting movement, whereas the generic prior art uses a strictly linear plug connection at this point, if only to provide additional electrical contact between the plug contacts there and the associated sockets.

In contrast, the invention works without an electrical connection, i.e. there is no electrical connection between the electrical component carrier and the lock housing, but rather a purely mechanically detachable coupling. This means that the electrical component carrier can be detachably coupled to the lock housing during a pivoting movement while the latching connection is made, because an electrical connection is expressly not required during this process. This also rules out any malfunctions or damage to the electrical connection, which is therefore not realized, from the outset. These are the main advantages.

In a further advantageous embodiment, the electrical component carrier is equipped with a pivot stop for engaging in a pivot recess on the lock housing in addition to the latching lug. This means that to realize the pivoting movement when the electrical component carrier and the lock housing are joined, the electrical component carrier engages with its pivot stop in the associated pivot recess on the lock housing. It is also usually the case that the latching lug and the pivot stop on the electrical component carrier are largely opposite one another.

In this context, it has also proven useful if the latching lug and the pivot stop are arranged on a mounting flange of the electrical component carrier. The electrical component carrier is also equipped with a centering lug to ensure that it can be properly secured to the lock housing when making the latching connection. The centering lug can be arranged on the mounting flange, advantageously between the latching lug and the pivot stop. In addition, the design in this context is such that the centering lug engages in an associated centering recess on the lock housing when the electrical component carrier is mounted.

It is also a subject matter of the invention to provide a method of manufacturing a motor vehicle lock assembly of the embodiment described above. In the course of the pivoting movement of the electrical component carrier relative to the lock housing, the latching lug of the electrical component carrier engages releasably and electrically connection-free in the latching recess of the lock housing. In addition, the design is such that the pivoting movement of the electrical component carrier relative to the lock housing is designed as a circular arc movement. To realize the circular arc or the circular arc movement, the pivot stop acts as the center of the respective circular arc. The centering nose also ensures centering during this pivoting movement by increasingly dipping into the centering recess of the lock housing during the pivoting movement.

As a result, a motor vehicle lock assembly and an associated method for its manufacture are described, both of which are characterized by a particularly functional and simple design. In addition, the absence of an electrical connection between the electrical component carrier and the lock housing ensures that the two components can be joined in the course of a pivoting movement and, in particular, circular movement. This makes installation particularly intuitive and simple, particularly as the centering lug engaging in the centering recess additionally centers the electrical component carrier in relation to the lock housing during this process.

The lock housing can basically be a plastic housing that encloses the vehicle lock. As a rule, however, the lock housing for mounting the locking mechanism acts as a lock housing or counterpart for the electrical component carrier that can be detachably attached to it. For its part, the electrical component carrier is typically equipped with at least one electrical or electronic component arranged on or near it. This may involve one or more sensors, for example one or more switches and in particular microswitches.

In addition, the electrical component carrier has a plastic carrier plate in which a punched grid may have been embedded and enclosed by a plastic injection molding process. In addition, the electrical component carrier is usually equipped with a molded connection socket. The electrical/electronic component carried by the electrical component carrier can be electrically coupled to a control unit on the door or body side, for example, via the connection socket. All that is required is for a plug to be inserted into the connection socket after the electrical component carrier has been fitted to the lock housing, providing the necessary electrical connection. These are the main advantages.

In the following, the invention is explained in more detail with the aid of a drawing showing only an exemplary embodiment; in the figures:

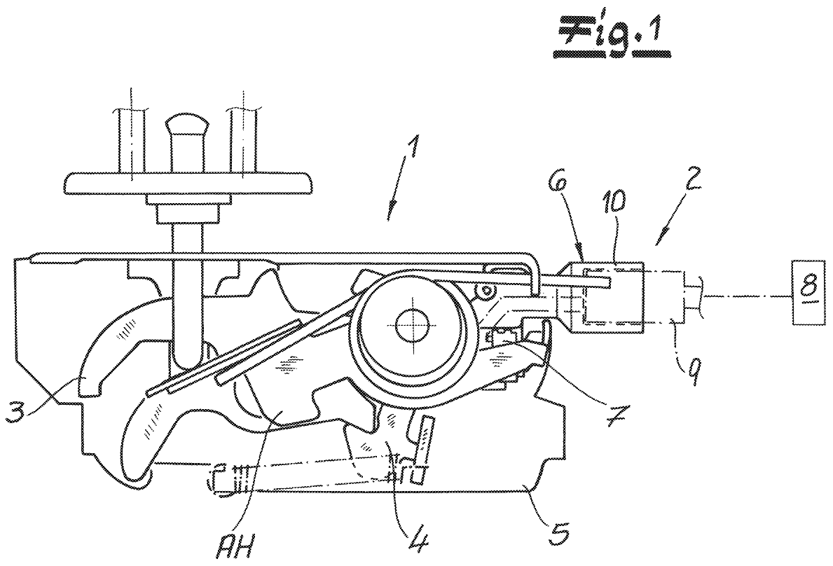

FIG. 1 shows an overview of the motor vehicle lock assembly according to the invention in the form of a motor vehicle Bonnet lock assembly,

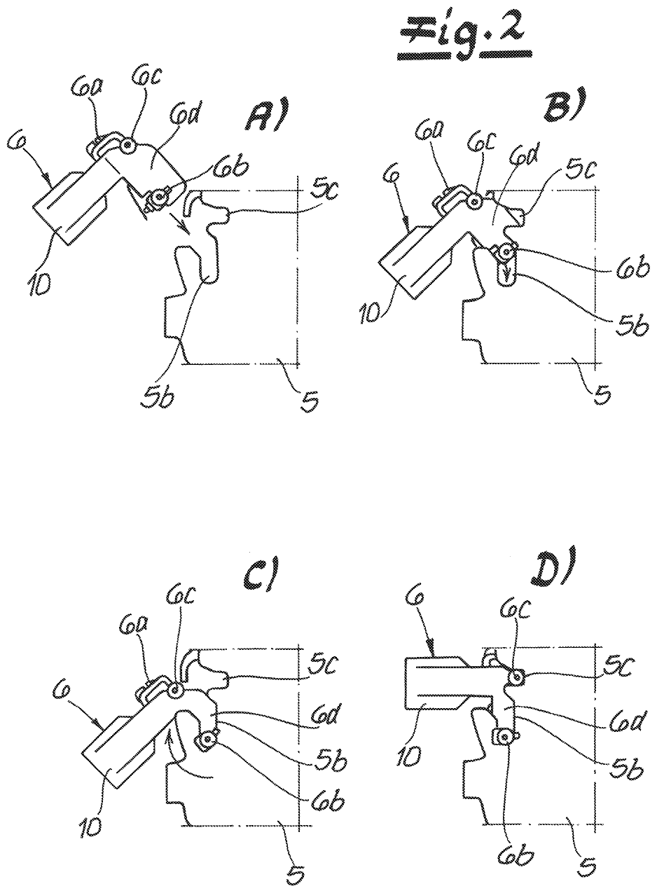

FIG. 2A to 2D show the mounting of the electrical component carrier on the lock housing and

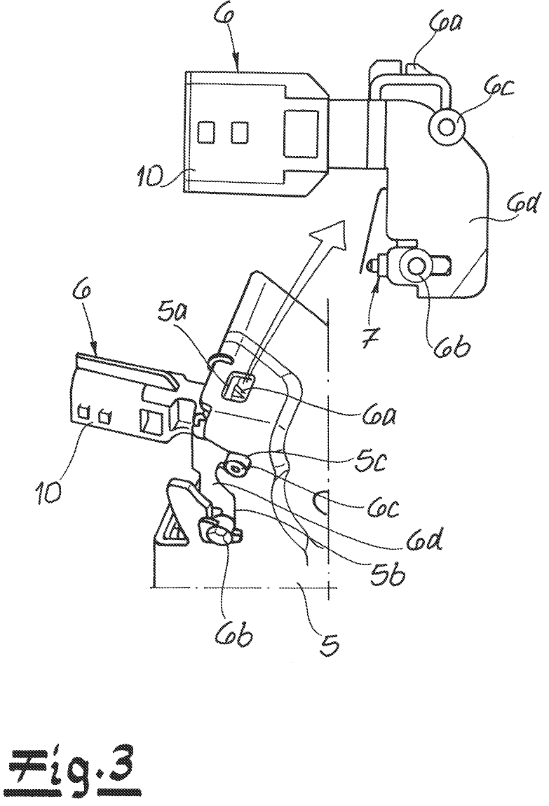

FIG. 3 shows a perspective view of a detail of the electrical component carrier mounted on the lock housing.

The figures show a motor vehicle lock assembly and, in particular, a motor vehicle bonnet lock assembly. This has a mechanical module 1 and an electrical module 2, which are designed and manufactured separately and then combined to form the bonnet lock, as will be explained in more detail below.

For this purpose, the mechanical module 1 is equipped with at least one locking mechanism 3, 4 consisting of a catch 3 and a pawl 4 interacting therewith. In the illustration according to FIG. 1, the locking mechanism 3, 4 is shown in its closed state. The locking mechanism 3, 4 is rotatably mounted in a lock case 5, which in the exemplary embodiment functions as a lock housing 5, to which an electrical component carrier 6 is detachably attached as part of the electrical module 2 within the scope of the invention. In this manner, the mechanical module 1 and the electrical module 2 are combined to form the vehicle bonnet lock shown. This is used, for example, to close a hood (not shown) against a vehicle body.

The electrical component carrier 6 is equipped with at least one electrical/electronic component 7 arranged thereon or thereat. The electrical/electronic component 7 is, in the context of the exemplary embodiment and not restrictively, a sensor or switch 7, with the aid of which the position of an ejector lever AH can be queried, which, according to the exemplary embodiment, is mounted axially aligned with the pawl 4.

Of course, the position of another component of the mechanical module 1 can also be queried and sensed using the component 7 or the sensor or (micro) switch 7 implemented at this point. Corresponding signals from the component or switch 7 are now transmitted to a control unit 8, which is only indicated schematically. The control unit 8 is connected via a plug 9 to the electrical component carrier 6 or a connection socket 10 realized at this point, into which the plug 9 can be inserted for contacting. According to the exemplary embodiment, the connection socket 10 is molded onto the electrical component carrier 6 or forms a part of the electrical component carrier 6.

Consequently, the electrical component carrier 6 with the electrical/electronic component 7 arranged thereon and the connection socket 10 as a whole and according to the exemplary embodiment defines the electrical module 2, which is combined as a prefabricated structural unit with the mechanical module 1 to form the motor vehicle bonnet lock shown, as will be explained in more detail below.

In fact, according to the exemplary embodiment, the electrical module 2 can be detachably attached to the lock housing 5 of the mechanical module 1. For this purpose, according to the exemplary embodiment and in accordance with the invention, the electrical component carrier 6 of the electrical module 2 is detachably engaged in a corresponding latching recess 5a of the lock housing 5 of the mechanical module 1 by means of a latching lug 6a, which can be recognized in particular in FIG. 3 and is, for example, integrally formed. Furthermore, the design in this context is such that the latching connection 5a, 6a realized in this manner between the latching nose 6a and the latching recess 5a is established in the course of a pivoting movement between the electrical component carrier 6 and the lock housing 5, as can be understood from the sequence of figures in FIGS. 2A to 2D. Furthermore, the coupling between the electrical component carrier 6 and the lock housing 5 is realized electrically connection-free in the context of the exemplary embodiment and in accordance with the invention, i.e. at this point there is only a mechanical connection between the electrical component carrier 6 and the lock housing 5, without an additional electrical connection being made or being necessary in this context.

For this purpose, the electrical component carrier 6 is equipped with a pivot stop 6b in addition to the latching lug 6a. The pivot stop 6b serves to engage in a corresponding pivot recess 5b on the lock housing 5, as can be seen in particular in the transition from FIG. 2A to FIG. 2B. The overall design is such that the latching lug 6a and the pivot stop 6b on the electrical component carrier 6 are largely opposite one another, as can be seen in FIG. 2A, for example. This also shows that the latching lug 6a and the pivot stop 6b are arranged on a fastening flange 6d of the electrical component carrier 6. The mounting flange 6d also has a centering lug 6 c. In addition, the mounting flange with the latching lug 6a, the pivot stop 6b and the centering lug 6c is formed on the electrical component carrier 6.

The centering lug 6c is not only arranged on the fastening flange 6d of the electrical component carrier 6, but also between the latching lug 6a and the pivot stop 6b. In this manner, the centering lug 6c can engage in a centering recess 5c of the lock housing 5 when the electrical component carrier 6 is mounted on the lock housing 5.

Consequently, the assembled state in FIG. 2D shows that the latching lug 6a on the electrical component carrier 6 engages in the latching recess 5a of the lock housing 5. The centering lug 6c of the electrical component carrier 6 is also in engagement with the associated centering recess 5c of the lock housing 5. Finally, this unification is achieved by the fact that during this process the electrical component carrier 6 is arranged with its pivot stop 6b in the associated pivot recess 5b and in this manner the pivoting movement or circular arc movement can be carried out with the pivot stop 6b as the center point, as can be seen in the transition from FIG. 2C to FIG. 2D.

While the lock housing or lock case 5 is made of metal and in particular high-strength steel, which also typically applies to the catch 3, the pawl 4 and the ejector lever AH, the electric component carrier 6, on the other hand, is usually made of plastic. This is usually a plastic injection-molded part. During the plastic injection molding process, the punched grid inside the electrical component carrier 6, which cannot be expressly identified, is encased in plastic and thus electrically insulated and protected from environmental influences. Nevertheless, the electrical/electronic component 7 can be contacted with the punched grid. The punched grid also merges into the connection socket 10 so that the desired electrical connection can be made with the plug 9 and finally the control unit 8 in the installed state.

FIGS. 2A to 2D show the installation process or manufacturing process for combining the mechanical module 1 with the electrical module 2. Based on FIG. 2A, the electrical component carrier 6 with its pivot stop 6b is first inserted into the associated and elongated pivot recess 5b in the lock housing 5 for this purpose. This can be seen in the transition from FIG. 2A to FIG. 2B and finally in FIG. 2C, which shows the final state during this insertion process of the pivot stop 6b into the pivot recess 5b.

As soon as the pivot stop 6b is located at the base of the pivot recess 5b of the lock housing 5, as shown in FIG. 2C, the pivot stop 6b can be used as the center point for a pivoting movement of the electrical component carrier relative to the lock housing 5. This is shown by an arrow in FIG. 2C. During this pivoting movement, the electrical component carrier 6 is pivoted clockwise by approximately 45° along an arc of a circle around the center point in question or the pivot stop 6b according to the exemplary embodiment. During this process, the centering lug 6c on the electrical component carrier 6 increasingly dips into the predominantly horizontal centering recess 5c of the lock housing 5, thereby centering and aligning the electrical component carrier 6 relative to the lock housing 5.

At the end of this pivoting movement, as shown in FIG. 2D, the latching lug 6a on the electrical component carrier 6 can engage in the latching recess 5a in the lock housing 5. Now the electrical component carrier 6 is aligned with the lock housing 5 and the motor vehicle bonnet lock is mounted according to the exemplary embodiment. For an electrical connection between the component 7 and the control unit 8, it is only necessary to insert the plug 9 into the connection socket 10.

### LIST OF REFERENCE SIGNS

mechanical module 1
electrical Module 2
catch 3
locking mechanism 3, 4
pawl 4
lock case 5
lock housing 5
latching connection 5a, 6a
latching recess 5a
pivot recess 5b
electrical component carrier 6
latching lug 6a
pivot stop 6b
centering nose 6c
mounting flange 6d
lug 6c
component 7
switch 7
control unit 8
ejector lever AH
plug 9
connection socket 10

1. A motor vehicle lock assembly vehicle comprising:
a mechanical module and
an electrical module,
wherein the mechanical module has at least one locking mechanism and a lock housing,
wherein the electrical module has at least one electrical component carrier and at least one electrical component arranged on the at least one electrical component carrier,
wherein the electrical module is fastened to the lock housing of the mechanical module, and
wherein the electrical component carrier includes a latching lug, and the latching lug engages in a corresponding latching recess of the lock housing of the mechanical module in a detachable and electrically connection-free manner during a pivoting movement while the electrical component carrier engages and disengages the lock housing.

2. The motor vehicle lock assembly according to claim 1, wherein the electrical component carrier has a pivot stop for engagement in a pivot recess on the lock housing.

3. The motor vehicle lock assembly according to claim 2, wherein the latching lug and the pivot stop on the electrical component carrier are opposite one another.

4. The motor vehicle lock assembly according to claim 2, wherein the latching lug and the pivot stop are arranged on a fastening flange of the electrical component carrier.

5. The motor vehicle lock assembly according to claim 4, wherein the electrical component carrier has a centering lug.

6. The motor vehicle lock assembly according to claim 5, wherein the centering lug is arranged on the fastening flange between the latching lug and the pivot stop.

7. The motor vehicle lock assembly according to claim 5, wherein the centring lug engages in a centring recess of the lock housing when the electrical component carrier is mounted.

8. A method of producing a motor vehicle lock assembly,
wherein the motor lock assembly has-comprising a mechanical module and an electrical module, wherein the mechanical module comprises at least one locking mechanism and a lock housing, wherein the electrical module has at least one electrical component carrier having a mounting flange with a latching portion and a pivoting portion and at least one electrical component arranged on the at least one electrical component carrier, wherein the mounting flange has a latching lug on the latching portion of the mounting flange and the lock housing has a corresponding latching recess, and wherein the mounting flange has a pivot stop at the pivoting portion of the mounting flange and the lock housing has a pivot recess,
the method comprising the steps of:
inserting the pivot stop of the mounting flange of the at least one electrical component carrier into the pivot recess of the lock housing; and
rotationally engaging, by a pivoting movement, the at least one electrical component carrier with the lock housing such that the latching lug detachably engages the latching recess of the lock housing in an electrically connection-free manner.

9. The method according to claim 8, wherein the pivoting movement of the electrical component carrier takes place as a circular arc movement about the pivot stop of the electrical component carrier as a center point.

10. The method according to claim 8, wherein the electrical component carrier is additionally centred during the pivoting movement by a centring lug of the electrical component carrier plunging into a centring recess on the lock housing.

11. The motor vehicle lock assembly according to claim 2, wherein the pivot stop engaged in the pivot recess of the lock housing is configured to act as a center point during the pivoting movement while the electrical component carrier engages and disengages the lock housing.

12. The motor vehicle lock assembly according to claim 7, wherein the latching lug and the centering lug disengage from the corresponding latching recess and centering recess, respectively, before the pivot stop disengages from the pivot recess during the pivoting movement while the electrical component carrier disengages the lock housing.

13. The motor vehicle lock assembly according to claim 1, wherein the lock housing of the mechanical module is plastic.

14. The motor vehicle lock assembly according to claim 1, wherein the electrical component carrier further has a connection socket configured to make connections between an electrical component carried by the electrical component carrier and a control unit located outside the motor vehicle lock assembly.
